(19) United States
(12) Patent Application Publication
(10) Pub. No.: US 2005/0265288 A1
(43) Pub. Date: Dec. 1, 2005

(54) Apparatus and method capable of automatic allocation of operating channels in a wireless network

(76) Inventors: Jiewen Liu, San Diego, CA (US); Chih C. Tsien, San Diego, CA (US)

Correspondence Address: INTEL CORPORATION, P.O. BOX 5326, SANTA CLARA, CA, 95056-5326, US

(21) Appl. No.: 10/855,907

(22) Filed: May 27, 2004

(51) Int. Cl. H04Q 7/00

(52) U.S. Cl. 370/332; 370/338

(57) ABSTRACT

Briefly, in accordance with one embodiment of the invention, an apparatus, comprising at least one access point (AP) in a wireless network; and the access point (AP) capable of channel allocation based on predetermined criteria. The wireless network may be a wireless local area network (WLAN) and the channel allocation may be automatic and the predetermined criteria may be allocating a channel which minimizes the interferences among other APs in the network by selecting a channel in the wireless network which has the lowest signal strength level, and/or has less interferences from neighboring cells and/or has an appropriate allocation with spectrum spreading uniformly over the frequency band.

### BACKGROUND

Wireless networks are superior to wired networks with regard to aspects such as ease of installation and flexibility. They do, however, suffer from lower bandwidth, higher delays, higher bit-error rates, and higher costs than wired networks. With the advent of Wireless Local Area Networks (WLANs), band-width has increased and prices have decreased on wireless networking solutions. These factors have made WLANs a very popular wireless networking solution.

The Institute of Electrical and Electronics Engineers (IEEE) 802.11 standard for WLANs is the most widely used WLAN standard today. Since it may use a shared medium, it has some inherent problems, such as low medium utilization, risk of collisions and channel saturation and choosing the best channel.

Thus, there is an ongoing need in wireless communications for better wireless networks with improved methods and apparatus capable of automatic channel allocation.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates the maximum received signal strength measurements on each scanning channel;

FIG. 2 illustrates a channel allocation spreading uniformly over the frequency band;

FIG. 3 illustrates a 2.4 GHz Wireless Networking Frequency Planning scheme;

FIG. 4 illustrates a 5 GHz Wireless Networking Frequency Planning scheme; and

FIG. 5 is a flowchart of the process of the best channel selection of one embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause an effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like).

To properly allocate and select communication channels in a given operation environment may be a critical design consideration in various wireless communication networks. In various communication technologies and standards, either code channels, time or frequency channels, all may adopt proper channel selection mechanisms to reduce interferences and improve system capacity. Unlike a cellular network, where sophisticated algorithms and methods are well developed and applied for system deployment and interference minimization, a WLAN network has no standardized criteria and procedure for channel selection.

Although the scope of the present invention is not limited in this respect, an embodiment of the present invention may provide an improved frequency channel selection process in Access Points (AP) in a Wireless LAN (WLAN). A novel channel selection mechanism may be used to determine how to utilize frequencies appropriately among Access Points in a WLAN system. The present invention may determine the best frequency to be operated automatically by minimizing the interferences among other APs in the WLAN network. Automatically used herein is meant to include all functions taking place within the AP, or within the WLAN, or a combination of the two. It also includes user input and any combination of user input, AP control and overall WLAN system control. The present invention also includes non-automatic use.

In order to provide good wireless link quality, selecting a best channel for operation is an important consideration in wireless system design. A frequency channel considered to be a best channel may typically (not limited to but at least) meet the following criteria:
It has the lowest signal strength;
It has less interferences from neighboring cells; and
It has an appropriate allocation with spectrum spreading uniformly over the frequency band.

Although the scope of the present invention is not limited in this respect, the signal strength level on each channel, such as RSS (Received Signal Strength), SNR (Signal to Noise Ratio), etc, may be measured from detected 802.11 packets during an AP scanning on available channels. The received 802.11 packets can be beacons from neighboring APs and any data or management packets from stations (STA) nearby. However, any now known or later developed measurement methods for determination RSS, SNR or other signal criteria is intended to be within the scope of the present invention. The AP and associated STAs form a BSS (Basic Service Set) cell

During scanning, for example, signal strength on a channel may indicate if there are any BSS's operating on the channel. If no 802.11 packets are detected on a channel, this channel may have minimum signal strength level and may be considered as the cleanest or quietest channel. On the other hand, the maximum signal strength on a channel may be obtained from all detected packets. The stronger the signal strength is, the more interference there may be from this BSS cell. Therefore, the signal strength can provide a good reference for selecting an appropriate frequency channel. Although, it is understood that signal strength is not the only reference point for determination of an appropriate frequency channel. Based on interference tolerance level, a threshold may be chosen to determine whether a channel is clean enough to operate on. For example and not by way of limitation, it is possible to set the interference level below station sensitivity by 3 dB (i.e. for data rate of 24 Mbps, it could be −77 dBm).

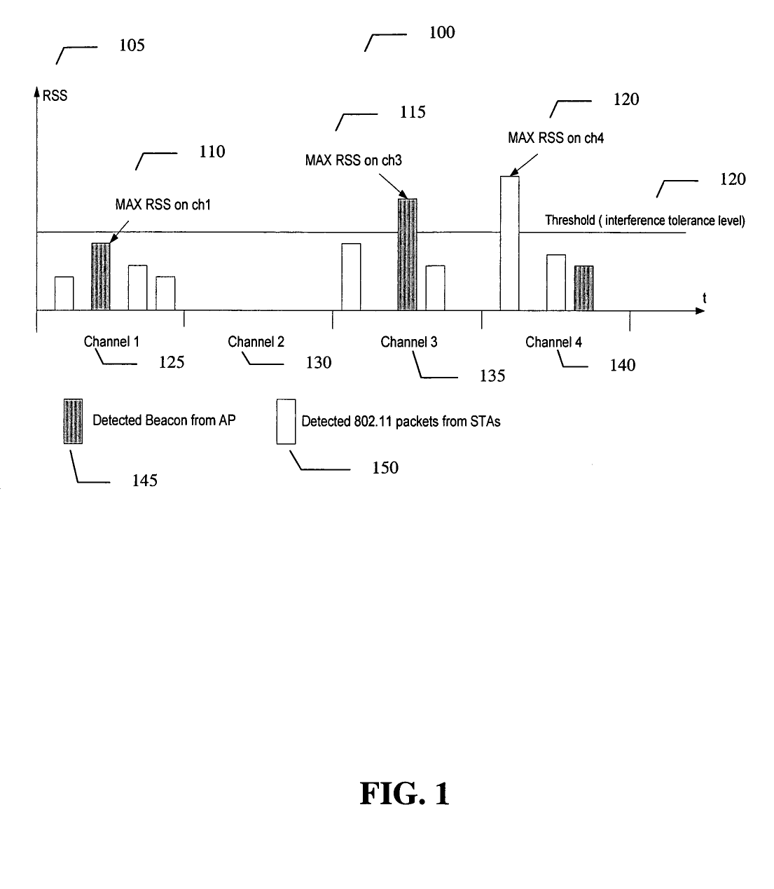

Turning now to FIG. 1, shown generally as 100, is illustrated the maximum received signal strength measurements, RSS 105, for each scanning channel. Hatched lines 145 indicate detected beacon from an AP and non-hatched markings 150 indicate any detected 802.11 packets. It is understood that the present invention can detect packets (and the present invention is not limited to only detecting packets) from any source. In FIG. 1 for example, channel 2 130 has the minimum signal strength level and may be the best channel among all four scanned channels. Besides channel 2 (if channel 2 is not available), channel 1 125 with Max RSS at 110 may be the best channel among channels 1 125, 3 135 with max RSS 115, and 4 140 with max RSS at 120, since the maximum signal strength 115 on channel 3 and 4 exceed the interference tolerance level 120.

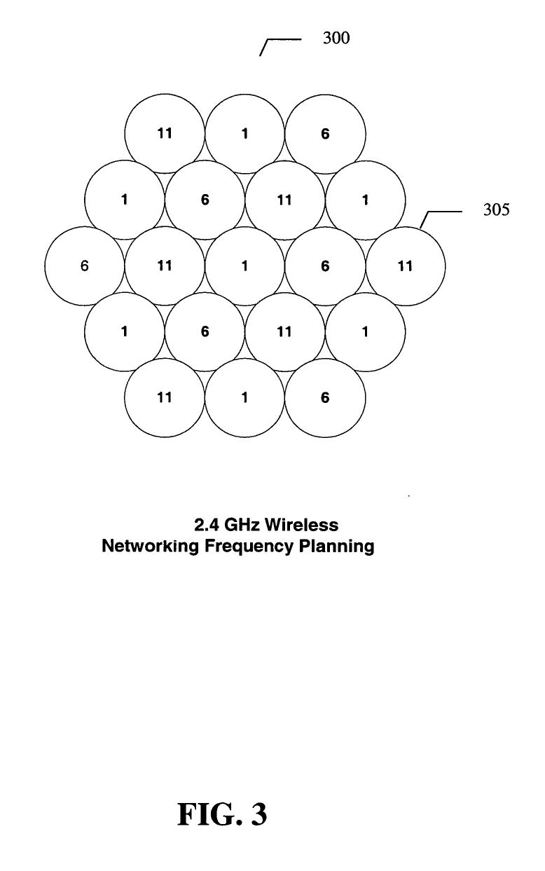

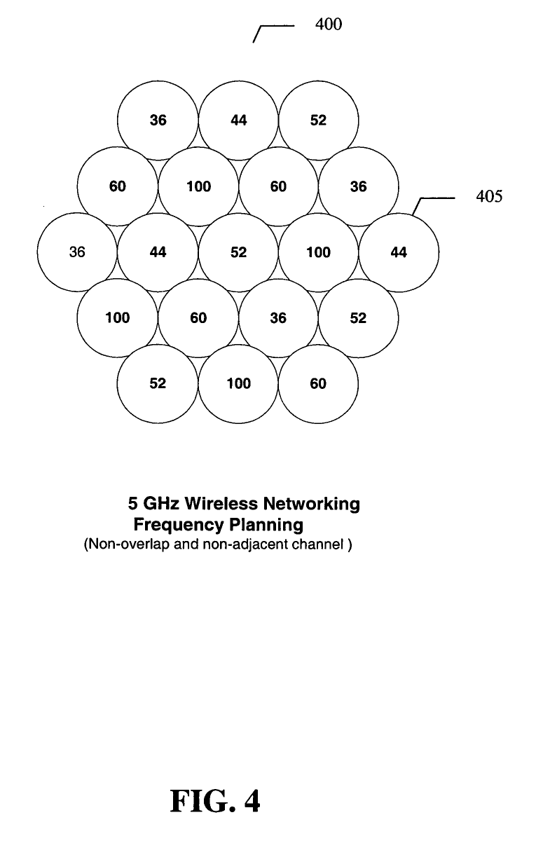

In a wireless network, the interferences could come from neighboring AP cells' fundamental frequency (co-channel interference), AP's spurious emission, neighboring APs' adjacent channel interference, and Stations' co-channel interference, adjacent channel interference, and spurious emission. It could also come from consumer electronics, industry and military facilities. Although the scope of the present invention is not limited to these interference sources and it is anticipated that interference can come from any number of additional interfering sources and can be measured by the present invention. To select an interference free channel is important to provide good link quality services. Although interference free is the goal, it is seldom completely obtainable, hence, the present invention includes the range from interference free to very high levels of relative interference and levels in between. In order to avoid or reduce neighboring cells interference, the network channel frequency may be well planned as illustrated below with reference to FIG. 3 and FIG. 4.

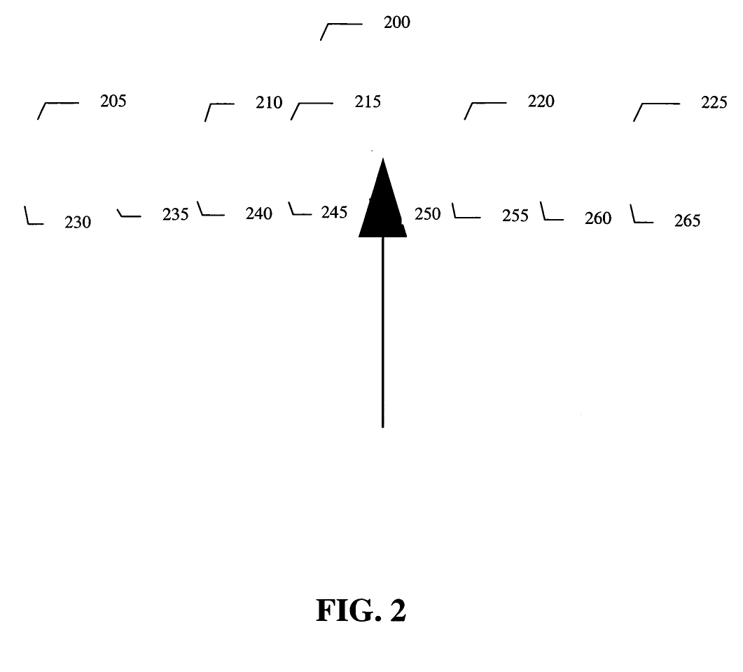

Uniformed spectrum spreading may allocate the channels uniformly over the entire frequency band such that the interference among channels being used may be minimized. Although the scope of the present invention is not limited in this respect. It may also be performed by collecting the signal strength on each channel during scanning, and then selecting through calculations appropriate channel location that is away from other operating channels. Although the scope of the present invention is not limited in this respect. This is illustrated in FIG. 2, shown generally as 200, wherein the appropriate channel should be located at channel 6 255 (instead of channel 2 235) if channels 1 230, 3 240, 4 245, and 8 265 have been occupied. Signal strength for channels are illustrated at 205, 210, 215, 220 and 225 with channels illustrated as channel 1, 230; channel 2, 235; channel 3, 240; channel 4, 245; channel 5, 250, channel 6, 255, channel 7, 260, channel 8, 265. This technique reduces cumulated energy to interference and reduces collision among channels. Therefore, it enhances the system performance and network capacity.

To take the above criteria into design consideration and determine and select a best operation channel for an AP, the procedure of frequency channel selection may be described as an embodiment as follows, for example,
AP powers up and performs system configuration
During the configuration, there may be two options to select a channel: a) selecting a specific channel, or b) choosing auto channel selection, in which AP shall perform the channel selection function and the proposed mechanism can then be applied. Although two options are listed here, it is anticipated that several other options for configurability are within the scope of the present invention such as, but not limited to, semi-automatic channel selection, selecting a specific channel and then subsequently automatically selecting a channel, always selecting a channel, sometimes selecting a channel, or other combinations of automatic and prior channel selection.

When choosing auto channel selection, the AP performs scanning for all available channels (available channels can be determined by supported radio band, regulatory limits, and radar detection results, although the scope of the present invention is not limited in this respect). For each channel being scanned, all the information related to channel selection (i.e. signal strength level, interference, spurious emission, and uniformed spectrum described above) may be recorded. However, it is anticipated that all information does not have to be recorded and it is within the scope of the present invention to scan all, some or none of the information depending on the parameters desired of the present invention. The channels that have the lowest signal strength and the least interference may be kept as the best channel candidates, while the channels that couldn't meet the criteria may be filtered out. If multiple candidate channels are available, it is possible to select the one where the allocation assists to spreading the channel uniformly. When scanning is completed, the best channel may then be selected. The AP may use the selected channel as operating frequency and start beaconing.

To select an interference free channel it may be important to provide good link quality services. Turning back to FIG. 3, illustrated generally at 300, is a good example of a good 2.4 GHz network frequency planning which avoids or reduces neighboring cell interference in a network channel. An individual cell is illustrated at 305.

FIG. 4, illustrated generally at 400, is an example of a good 5 GHz network frequency planning which avoids or reduces neighboring cell interference in a network channel and provides non-overlap and non-adjacent channels. An individual cell is illustrated at 405. It is understood that although a 2.4 GHz and 5 GHz frequencies are illustrated herein, the present invention is not limited to these frequencies.

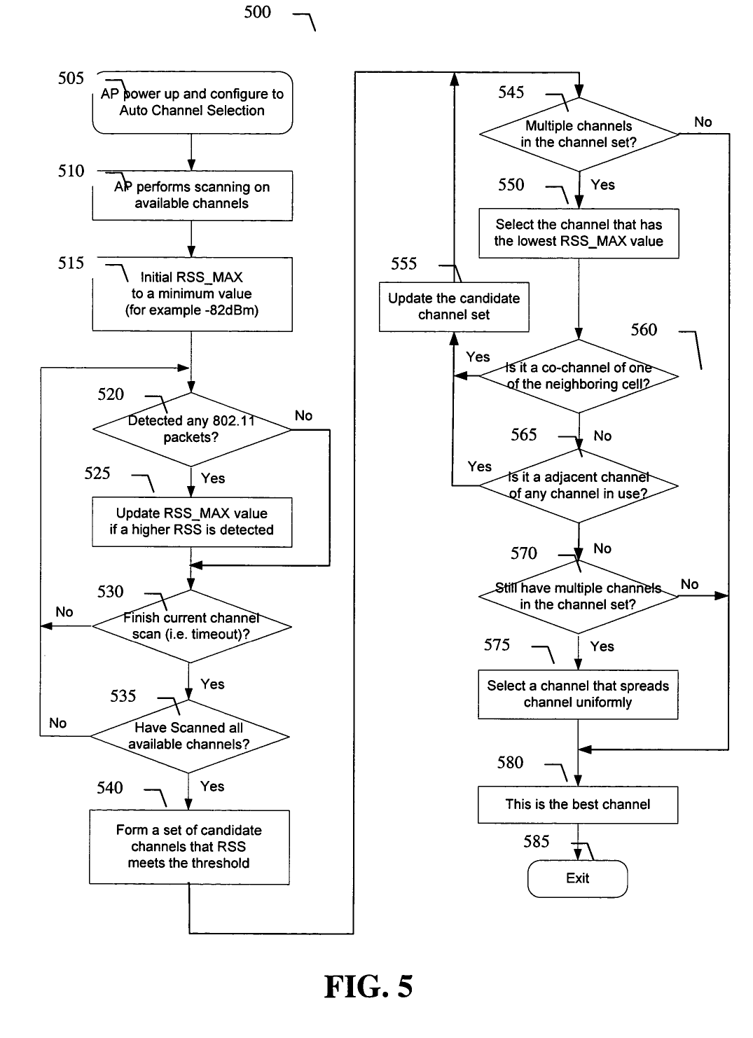

Turning now to FIG. 5 illustrated generally at 500 is the process of the best channel selection of an embodiment of the present invention which comprises providing at least one access point (AP) in a wireless network and allocating channels used by said at least one access point (AP) in said wireless network based on predetermined criteria. The wireless network may be a wireless local area network (WLAN) and the channel allocation may be automatic and the predetermined criteria may be allocating a channel which minimizes the interferences among other access points (APs) in the network.

The allocation of a channel which minimizes the interference among other access points (APs) in the network may be provided by selecting a channel in the wireless network which has the lowest signal strength level, and/or has less interference from neighboring cells and/or has an appropriate allocation with spectrum spreading uniformly over the frequency band. The signal strength level on each channel may be the Received Signal Strength (RSS) or may be Signal to Noise Ratio (SNR). Although the scope of the present invention is not limited in this respect, as signal strength level may be measured from any number of parameters. Further, the signal strength may be measured from detected 802.11 packets while the access point (AP) scans on available channels and wherein the received 802.11 packets may be beacons from a neighboring AP and/or any data or management packets. Again, numerous other measuring points are anticipated to be within the scope of the present invention and the 802.11 packets are but one included herein as an illustrative embodiment.

The automatic allocation of channels mentioned above may comprise scanning by the at least one AP for all available channels and recording information related to channel selection for each channel being scanned; and allocating the channels that meet or exceed the predetermined criteria as best channel candidates and filtering out channels that do not meet the predetermined criteria. If multiple candidate channels meet or exceed the predetermined criteria, the channel wherein the allocation assists to spread the channel uniformly may be selected. The information recorded related to the channel selection may be selected from the group consisting of: signal strength level, interference, spurious emission, and uniformed spectrum. Although the scope of the present invention is not limited to this group.

An embodiment of the present invention provides power up 505 wherein the AP power's up and configures to auto channel selection. At 510 the AP performs scanning on available channels with initialization of RSS_MAX to a minimum value at 515. Whether or not there may be detection of any 801.11 packets may be determined at 520. If yes, then at 525 the RSS_MAX value may be updated if a higher RSS is detected. If no, at 530 a determination may be made if the channel scan is finished. If no at 530, then a return to 520 may be accomplished. If yes at 530, then a determination may be made at 535 if all available channels have been scanned. If no at 530, then the process may return to 520. If yes at 535, then a set of candidate channels that RSS meets the threshold may be formed. The process continues at 545 where a determination may be made if there are multiple channels in the channel set? If yes, the process may select at 550 the channel that has the lowest RSS_MAX value and at 560 a determination may be made if the selection at 550 is a co-channel of one of the neighboring cells. If yes at 560, at 565 a determination may be made as to whether or not it may be an adjacent channel of any channel in use. If yes at 565, than the candidate channel set may be updated and the process may return to 545. If no at 565, a determination may be made if there are still multiple channels in the channel set at 570. If no at 570, the process may return to step 545. If yes at 570, a channel selection may be made that spreads the channel uniformly. Returning now to 545, if no at 545 the process may proceed to 580. After 575 or if no at 545, at 580 it may be determined that the best channel has been ascertained and the process may exit at 580.

An embodiment of the present invention further provides an article comprising a storage medium having stored thereon instructions, that, when executed by a computing platform allocates channels used by an access point in a wireless network based on predetermined criteria. The wireless network may be a wireless local area network (WLAN) and the channel allocation may be automatic and the predetermined criteria may be allocating a channel which minimizes the interferences among other APs in the network. Although the scope of the present invention is not limited in this respect.

The allocation of a channel which minimizes the interference among other APs in the network may be provided by selecting a channel in the wireless network which has the lowest signal strength level, or has less interferences from neighboring cells or has an appropriate allocation with spectrum spreading uniformly over the frequency band. The automatic allocation of channels may comprise scanning by the at least one AP for all available channels and recording information related to channel selection for each channel being scanned; and allocating the channels that meet or exceed the predetermined criteria as best channel candidates and filtering out channels that do not meet the predetermined criteria. Although the scope of the present invention is not limited in this respect.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus, comprising:
at least one access point (AP) in a wireless network; and
said access point (AP) capable of channel allocation based on predetermined criteria.

2. The apparatus of claim 1, wherein said wireless network is a wireless local area network (WLAN).

3. The apparatus of claim 1, wherein said channel allocation is automatic and said predetermined criteria is allocating a channel which minimizes the interferences among other APs in said network.

4. The apparatus of claim 3, wherein said allocation of a channel which minimizes the interference among other APs in said network is provided by selecting a channel in said wireless network which has the lowest signal strength level, and/or has less interferences from neighboring cells and/or has an appropriate allocation with spectrum spreading uniformly over the frequency band.

5. The apparatus of claim 4, wherein said signal strength level on each channel is the Received Signal Strength (RSS) or the Signal to Noise Ratio (SNR).

6. The apparatus of claim 4, wherein said signal strength is measured from detected 802.11 packets while said at least one access point (AP) scans on available channels.

7. The apparatus of claim 6, wherein said received 802.11 packets are beacons from a neighboring access point (AP) and any data or management packets from stations (STA) associated with said at least one access point (AP).

8. The apparatus of claim 3, wherein said automatic allocation of channels comprises:
scanning by said at least one access point (AP) for all available channels and recording information related to channel selection for each channel being scanned; and
allocating said channels that meet or exceed said predetermined criteria as best channel candidates and filtering out channels that do not meet said predetermined criteria.

9. The apparatus of claim 8, wherein if multiple candidate channels meet or exceed said predetermined criteria, a channel wherein said allocation assists to spreading said channel uniformly is selected.

10. The apparatus of claim 8, wherein said information recorded related to said channel selection is selected from the group consisting of: signal strength level, interference, spurious emission, and uniformed spectrum.

11. A method of channel selection, comprising:
providing at least one access point (AP) in a wireless network; and
allocating channels used by said at least one access point (AP) in said wireless network based on predetermined criteria.

12. The method of claim 11, wherein said wireless network is a wireless local area network (WLAN).

13. The method of claim 11, wherein said channel allocation is automatic and said predetermined criteria is allocating a channel which minimizes the interferences among other access points (APs) in said network.

14. The method of claim 13, wherein said allocation of a channel which minimizes the interference among other access points (APs) in said network is provided by selecting a channel in said wireless network which has the lowest signal strength level, and/or has less interferences from neighboring cells and/or has an appropriate allocation with spectrum spreading uniformly over the frequency band.

15. The method of claim 14, wherein said signal strength level on each channel is the Received Signal Strength (RSS) or the Signal to Noise Ratio (SNR).

16. The method of claim 14, wherein said signal strength is measured from detected 802.11 packets while said access point (AP) scans on available channels.

17. The method of claim 16, wherein said received 802.11 packets are beacons from a neighboring AP and any data or management packets from stations (STA) associated with said at least one AP.

18. The method of claim 13, wherein said automatic allocation of channels comprises:
scanning by said at least one AP for all available channels and recording information related to channel selection for each channel being scanned; and
allocating said channels that meet or exceed said predetermined criteria as best channel candidates and filtering out channels that do not meet said predetermined criteria.

19. The method of claim 18, wherein if multiple candidate channels meet or exceed said predetermined criteria, the channel wherein said allocation assists to spread said channel uniformly is selected.

20. The method of claim 18, wherein said information recorded related to said channel selection is selected from the group consisting of: signal strength level, interference, spurious emission, and uniformed spectrum.

21. An article comprising a storage medium having stored thereon instructions, that, when executed by a computing platform allocates channels used by an access point in a wireless network based on predetermined criteria.

22. The article of claim 21, wherein said wireless network is a wireless local area network (WLAN).

23. The article of claim 21, wherein said channel allocation is automatic and said predetermined criteria is allocating a channel which minimizes the interferences among other APs in said network.

24. The article of claim 23, wherein said allocation of a channel which minimizes the interference among other APs in said network is provided by selecting a channel in said wireless network which has the lowest signal strength level, or has less interferences from neighboring cells or has an appropriate allocation with spectrum spreading uniformly over the frequency band.

25. The article of claim 23, wherein said automatic allocation of channels comprises:
scanning by said at least one AP for all available channels and recording information related to channel selection for each channel being scanned; and
allocating said channels that meet or exceed said predetermined criteria as best channel candidates and filtering out channels that do not meet said predetermined criteria.

26. The article of claim 25, further comprising selecting the channel wherein said allocation assists to spread said channel uniformly if multiple candidate channels meet or exceed said predetermined criteria,

27. A system, comprising:
at least one access point capable of providing access to a wireless local area network;
at least one wireless station (STA) capable of wireless communication with said at least one access point;
said at least one access point (AP) capable of automatic channel allocation based on predetermined criteria, wherein said automatic allocation of channels comprises:
scanning by said at least one AP for all available channels and recording information related to channel selection for each channel being scanned; and
allocating said channels that meet or exceed said predetermined criteria as best channel candidates and filtering out channels that do not meet said predetermined criteria.

28. The system of claim 27, wherein said predetermined criteria is criteria that minimizes signal strength level, interference, spurious emissions, and facilitates a uniformed spectrum.
